(19) United States
(12) Patent Application Publication
(10) Pub. No.: US 2023/0325125 A1
(43) Pub. Date: Oct. 12, 2023

(54) PREDICTIVE BLOCK STORAGE SIZE PROVISIONING FOR CLOUD STORAGE VOLUMES

(71) Applicant: ZESTY TECH LTD., Tel Aviv-Yafo (IL)

(72) Inventors: Alexey BAIKOV, Bat Yam (IL); Maxim MELAMEDOV, Netanya (IL); Alon Oshri KADASHEV, Tel Aviv (IL); Michael AMAR, Yerucham (IL)

(73) Assignee: ZESTY TECH LTD., Tel Aviv-Yafo (IL)

(21) Appl. No.: 18/210,111

(22) Filed: Jun. 15, 2023

Related U.S. Application Data
(63) Continuation-in-part of application No. 17/713,947, filed on Apr. 5, 2022, now Pat. No. 11,720,269.

(51) Int. Cl. G06F 3/06

(52) U.S. Cl. CPC G06F 3/067; G06F 3/0604; G06F 3/0631

(57) ABSTRACT

Systems and methods for managing computer block storage for a computer application include calculating an optimal required block storage capacity based on the storage needs of the application; provisioning block storage of the optimal capacity; receiving at least one block storage usage metric of the application; using a machine learning based model, trained on historic data of at least one application, to identify at least one future time at which a block storage capacity adjustment is required; and adjusting the block storage capacity within a time of the future time at which the block storage capacity adjustment is required.

### CROSS-REFERENCE TO RELATED APPLICATIONS

This application is a continuation-in-part of U.S. patent application Ser. No. 17/713,947, filed Apr. 5, 2022, which is hereby incorporated by reference in its entirety.

### FIELD OF THE INVENTION

The present invention relates generally to predicting trends in data storage usage, in particular to providing data storage capacity adjustment responsive to those predictions.

### BACKGROUND OF THE INVENTION

Many applications rely on storing data online on “the cloud”. The cloud may refer to computer servers which are accessed over the internet without a direct wired connection. Computer systems engineers face a continuous challenge of predicting and planning the required storage capacity for different cloud-based applications. Traditionally, ongoing maintenance of cloud-based applications (performed manually by cloud engineers) requires constant monitoring and optimization cycles to ensure stability and performance around the clock. A common practice is storage over provisioning, taking more resources than are actually needed. Storage over-provisioning involves making more storage available than can reasonably be expected to be used, thus minimizing the risk of data loss or crashes; it is, however, an inefficient technique leading to poor resource utilization and inflated cloud budgets. Such decisions are taken to support unpredictable business demand, and as cloud block storage does not automatically adjust itself to the constantly changing application needs, mistakes in estimating the required capacity may lead to application crashes, data loss, poor resource utilization, and waste of human efforts.

In traditional IT (information technology), “thin provisioning” is a mechanism that applies to large-scale centralized computer disk-storage systems, storage area networks (SANs), and storage virtualization systems. This concept allows a large number of storage consumers (e.g. virtual machines) to statically request storage blocks from the central storage system. However only the used blocks are actually written. Thin provisioning offers more efficiency where the number of resources used is much smaller than allocated.

The cloud's main promise is usage based elasticity, and while some fields do provide an elasticity model that can support modern development, cloud storage continues to utilize decades old concepts which in turn inflict negative effects on developers and cloud engineers. Cloud block storage volumes can only be increased in size on some clouds, and few cloud storage providers allow the customer to decrease their storage volume size. On top of that, the developer using the cloud is expected to predict the needed storage size.

There is therefore a need for storage provisioning which is adaptive to specific application needs.

### SUMMARY

Embodiments of the invention may include a method for managing computer data block storage for a computer application, the method including: calculating an optimal required block storage capacity based on the storage needs of the application; provisioning block storage of (e.g. defined by, equal to, etc.) the optimal capacity, thereby providing a safe buffer; receiving at least one block storage usage metric of the application for a predetermined period of time; using a machine learning based predictive model, trained on historic data of time periods of at least one application, to identify at least one future time at which a block storage capacity adjustment is required; and adjusting the block storage capacity within a predetermined time of the future time at which the block storage capacity adjustment is required.

According to some embodiments, the block storage capacity adjustment includes: identifying, by the predictive model, at least one future time at which the application requires less block storage than is currently provisioned; and removing a surplus capacity of block storage within a predetermined time of the future time at which the surplus storage is not required.

According to some embodiments, removed surplus block storage for the application is used as additional block storage for a second application.

According to some embodiments, the block storage capacity adjustment includes: identifying, by the predictive model, at least one future time at which the application requires more block storage than is currently provisioned; and provisioning, from at least one block storage provider, a required additional capacity of block storage within a predetermined time of the future time at which the required storage is required.

According to some embodiments, the step of provisioning the required additional capacity of block storage includes: comparing a block storage cost among more than one block storage provider; and provisioning block storage from the block storage provider offering the lowest cost for the required block storage.

According to some embodiments, the block storage is cloud block storage.

According to some embodiments, the method includes predicting, by the predictive model, a response time of at least one block storage provider to fulfil a request for block storage capacity adjustment.

According to some embodiments, block storage includes a plurality of storage blocks associated with at least one virtual block storage volume, wherein the plurality of storage blocks comprises at least one storage block of a first capacity, and at least one storage block of a capacity different to the first capacity, and wherein the at least one virtual block storage volume is distributed over one or more physical disks.

According to some embodiments, a block storage capacity adjustment includes removing surplus block storage starting with the storage block containing the least stored data based on a file system analysis of the application indicating which storage blocks contain data which is no longer required.

According to some embodiments, the machine learning based predictive model is one of: a neural network, or a reinforcement learning model.

According to some embodiments, the machine learning based predictive model is trained to predict behavior trends of the usage of storage data by the application based on a training set of time periods and data usage metrics corresponding to the set of time periods.

According to an embodiment, there is provided a method for managing block storage for an application, the method including: receiving at least one block storage usage metric of the application for a predetermined period of time; using a machine learning based predictive model, trained on historic data of time periods for at least one other application, to identify at least one future time at which a block storage adjustment is required; and adjusting a total size of the block storage within a predetermined time of the future time at which the block storage adjustment is required.

According to some embodiments, an initial minimum block storage size is provided based on the minimum block storage needs of the application.

According to some embodiments, the block storage adjustment includes: identifying, by the predictive model, at least one future time at which the application requires less block storage than is currently provisioned; and removing an excess amount of block storage within a predetermined time of the future time at which the excess storage is not required.

According to some embodiments, the block storage adjustment includes: identifying, by the predictive model, at least one future time at which the application requires more block storage than is currently provisioned; and creating a required additional size of block storage within a predetermined time of the future time at which the required storage is required.

According to an embodiment, there is provided a system for managing block storage for an application, the system comprising: a memory; and a processor, wherein the processor is configured to: receive at least one block storage usage metric of the application for a predetermined period of time; apply a machine learning based predictive model to identify at least one future time at which a block storage capacity adjustment is required; and adjust the block storage capacity within a predetermined time of the future time at which the block storage capacity adjustment is required.

According to some embodiments, the processor is configured to: identify at least one future time at which the application requires less block storage than is currently provisioned; and remove a surplus capacity of block storage within a predetermined time of the future time at which the surplus storage is not required.

According to some embodiments, the processor is configured to: identify at least one future time at which the application requires more block storage than is currently provisioned; and provide a required additional capacity of block storage within a predetermined time of the future time at which the required storage is required.

According to some embodiments, the machine learning based predictive model is trained on historic data of time periods for at least one other application.

According to some embodiments, the processor is configured to perform at least one of: copy-on-write of data, or RAID-0 disk striping.

According to some embodiments, a method for managing computer block cloud volume storage for a computer application includes: adjusting, based on a first storage action, an available size of computer block cloud volume storage by an amount based on a first storage factor when a storage utilization of the available computer block cloud volume storage passes a first threshold storage utilization value, wherein the first storage action is one of a storage increase or a storage decrease.

According to some embodiments, the first storage factor is a percentage value of computer block cloud volume storage utilization, or an absolute value of computer block cloud volume storage.

According to some embodiments, the first storage action, the first storage factor, and the first threshold storage utilization value are received as part of a user-defined input.

According to some embodiments, the first threshold storage utilization value represents a risk zone percentage value utilization, and the first storage factor represents a comfort zone percentage value utilization, wherein said adjustment is of a size which results in the storage utilization of the available computer block cloud volume storage changing from the risk zone percentage value utilization to the comfort zone percentage value utilization.

According to some embodiments, the method further includes performing the adjustment only if the available computer block cloud volume is within a predefined size range.

According to some embodiments, the method further includes adjusting, based on a second storage action, the available size of computer block cloud volume storage by an amount based on a second storage factor when a storage utilization of the available computer block cloud volume storage passes a second threshold storage utilization value, wherein the first storage action is a storage increase, and the second storage action is a storage decrease.

According to some embodiments, a system for managing computer block storage for a computer application includes: at least one processor; and a memory containing instructions which, when executed by the at least one processor, cause the at least one processor to: adjust, based on a first storage action, an available size of computer block cloud volume storage by an amount based on a first storage factor when a storage utilization of the available computer block cloud volume storage passes a first threshold storage utilization value, wherein the first storage action is one of a storage increase or a storage decrease.

According to some embodiments, the first storage factor is a percentage value of computer block cloud volume storage utilization, or an absolute value of computer block cloud volume storage.

According to some embodiments, the first storage action, the first storage factor, and the first threshold storage utilization value are received as part of a user-defined input.

According to some embodiments, the first threshold storage utilization value represents a risk zone percentage value utilization, and wherein the first storage factor represents a comfort zone percentage value utilization, wherein said adjustment is of a size which results in the storage utilization of the available computer block cloud volume storage changing from the risk zone percentage value utilization to the comfort zone percentage value utilization.

According to some embodiments, the at least one processor is configured to perform said adjustment only if the available computer block cloud volume is within a predefined size range.

According to some embodiments, the at least one processor is configured to adjust, based on a second storage action, the available size of computer block cloud volume storage by an amount based on a second storage factor when a storage utilization of the available computer block cloud volume storage passes a second threshold storage utilization value, wherein the first storage action is a storage increase, and the second storage action is a storage decrease.

According to some embodiments, a method for reducing computer block cloud volume storage for a computer application includes: reducing an available size of computer block cloud volume storage by an amount based on a first storage factor when a storage utilization of the available computer block cloud volume storage passes a first threshold storage utilization value, wherein said reducing comprises removing at least one disk from a unified filesystem.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a block diagram of a system according to an embodiment of the present invention;

FIG. 2 is a block diagram of a system according to an embodiment of the present invention;

FIG. 3 is a flowchart of a method according to an embodiment of the present invention;

FIG. 4A is a diagram of a system according to an embodiment of the present invention;

FIG. 4B is a diagram of a system according to an embodiment of the present invention;

FIG. 5 is a sequence diagram according to embodiments of the present invention;

FIG. 6 is a diagram of an example user interface, according to some embodiments of the present invention;

FIG. 7 is a flowchart of a method, according to some embodiments of the invention;

FIG. 8 is a diagram of an example user interface, according to some embodiments of the present invention;

FIG. 9 is a flowchart of a method, according to some embodiments of the invention; and

FIG. 10 is a graph of a simulation, according to some embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

As used herein “storage” is generally intended to refer to data computer data storage, as opposed to, for example, storage such as a shipping container. Cloud block storage services are a highly complex discipline, with various tier options and pricing plans to fit almost any need. The complexity is so great, that some companies prefer to pay 10-20 times the cost for the storage they actually need simply because they picked a suboptimal storage plan.

Cloud blocks/volumes may refer to virtual storage devices that can be attached to virtual machines. A virtual machine (VM) may be the virtualization or emulation of a computer system, and may provide the emulated functionality of a physical computer. Depending on the cloud vendor's offerings, cloud volumes can have different service level agreement (SLA), performance and pricing. Typically vendors will limit the maximum volume size, new volume creation rate, and ability to extend the volume size while in-use. Furthermore, virtual machines have their own limitations on the number of volumes that can be attached. Cloud volume may be an array of storage blocks that the user reserves for a virtual machine to use. The filesystem of the virtual machine may be responsible for managing the distribution of data blocks and their allocation on the block storage volume, hence an ordinary block device (e.g. a virtual machine with associated block storage) may be unable to decrease the number of blocks since it is unaware of the filesystem allocation. Removing any block without taking filesystem layout into consideration may result in data loss and filesystem corruption. Engineering teams have to take all of the above constraints into account while predicting the required disk size to fulfill the immediate and future demand for each application or microservice deployed to the cloud.

Real world applications have different storage requirements during runtime that can be impacted by the application internal logic (e.g. larger dataset to process) or externally by elements such as the business peak hours or change in the input data. Block storage volumes require constant monitoring and alerting solutions to collect and analyze usage metrics, such as free and used space, and notify when capacity is reaching a predefined threshold.

Embodiments of the present invention include a predictive cloud storage management system that automatically adjusts cloud volume capacity to meet application storage demand in real time by aggregating multiple cloud volumes (e.g. block storage devices) into a unified filesystem. A decision making engine, which may include a machine learning based model, may ensure that an application has the required amount of storage space at any moment while maintaining the highest possible level of resource utilization.

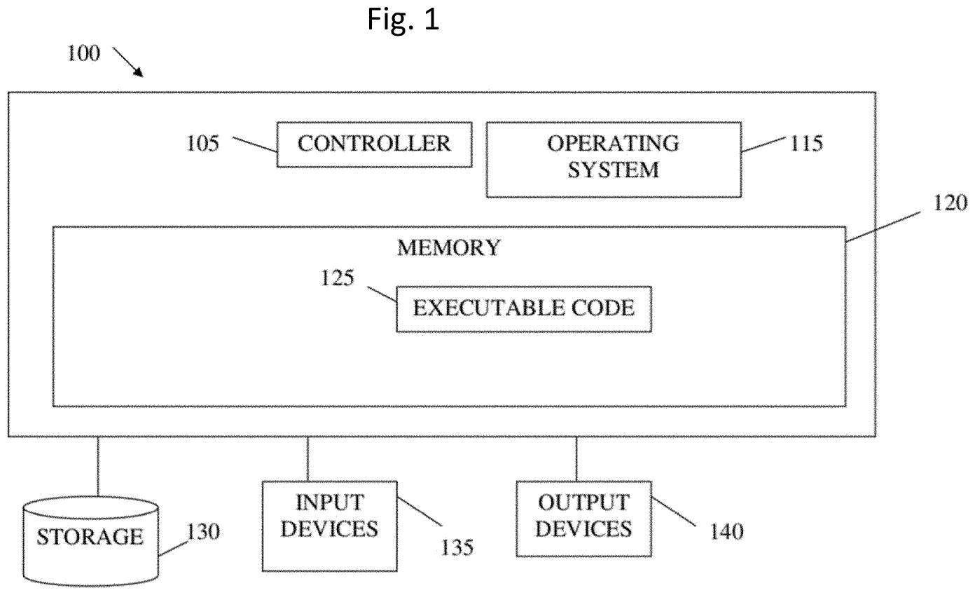

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. At least a portion of Memory 120 may include data storage housed online on the cloud. Memory 120 may be or may include a plurality of different memory units. Memory 120 may store for example, instructions (e.g. code 125) to carry out a method as disclosed herein. Memory 120 may use a datastore, such as a database.

Executable code 125 may be any application, program, process, task, or script. Executable code 125 may be executed by controller 105 possibly under control of operating system 115. For example, executable code 125 may be, or may execute, one or more applications performing methods as disclosed herein, such as a machine learning model, or a process providing input to a machine learning model. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105. Storage 130 may include cloud storage. Storage 130 may include storing data in a database.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (MC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

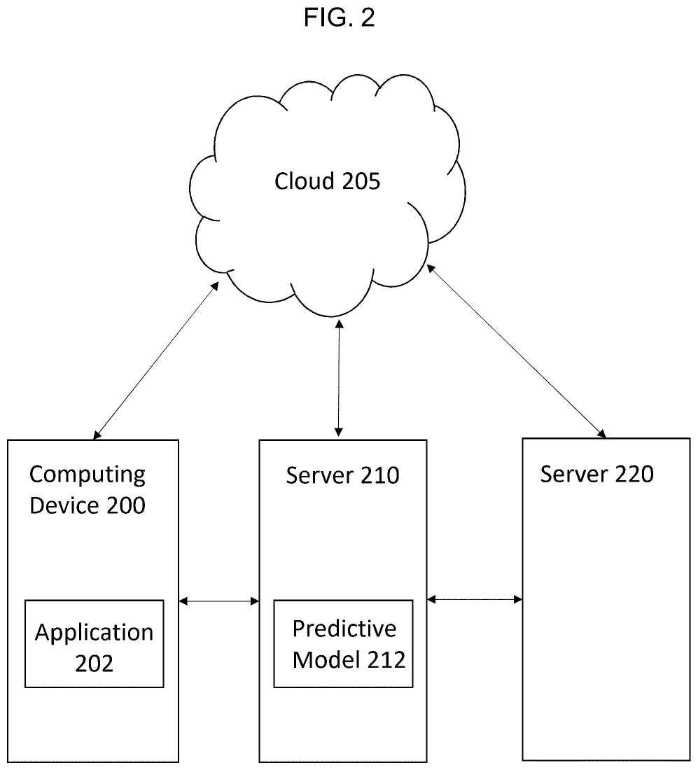

FIG. 2 shows a general environment in which some embodiments of the present may operate. Computing device 200 may be a computing device according to FIG. 1 and may be, for example, a personal computer, tablet, smartphone etc. Computing device 200 may run application 202. Application 202 may be an application which uses cloud-based functionality and/or storage. Application 202 may communicate with cloud 205 by way of computing device 200.

Server 210 may be a computing device according to FIG. 1. Server 210 may be responsible for running procedures according to embodiments of the present invention, for example, server 210 may manage block storage on cloud 205 for application 202 by executing methods disclosed herein. Server 210 may facilitate a software as a service (SAAS) product according to embodiments of the present invention.

Server 210 may include a predictive model 212. Predictive model 212 may be a machine learning based predictive model, for example a reinforcement learning based model, or neural network. Predictive model 212 may be trained on historic data in order to make predictions, for example in order to make predictions about upcoming data storage needs of application 202. Predictive model 212 may obtain storage usage data (e.g. one or more storage usage metrics) from application 202 by communicating via server 210 with computing device 200 running application 202.

Server 220 may be a server of a storage provider, for example a third party storage provider. Server 220 may be a computing device according to FIG. 1. Server 220 may include a physical storage system, such as a plurality of physical disk drives. Server 220 may provide cloud block storage, for example virtual block storage volumes in a virtual layer over the physical disk drives.

Server 210 may communicate with server 220, for example to request the provision of additional block storage to cloud 205 for application 202. Provisioning may mean, for example, at least one of purchasing, creating, reserving and/or assigning a portion of data storage for use by the cloud-based application, and may include provisioning data storage from a third party data storage provider. Server 210 may communicate with server 220 to request the release/removal of block storage from cloud 205 for application 202.

In some embodiments, server 210 may generate and provide storage on cloud 205 for application 202 independently of a third party storage provider, e.g. an operating entity of server 220. Server 210 may generate or remove storage for application 202 automatically in response to predictions made by predictive model 212.

A machine learning model, such as machine learning based predictive model 212, may include a neural network (NN) and may receive input data. According to some embodiments of the invention, the input data may be a time series, for example a discrete time series of storage data usage measurements or metrics. A machine learning model according to embodiments of the invention may output predictions calculated, estimated, or derived on the basis of function approximation and/or regression analysis.

A neural network may include neurons or nodes organized into layers, with links between neurons transferring output between neurons. Aspects of a NN may be weighted, e.g. links may have weights, and training may involve adjusting weights. A positive weight may indicate an excitatory connection, and a negative weight may indicate and inhibitory connection. A NN may be executed and represented as formulas or relationships among nodes or neurons, such that the neurons, nodes, or links are “virtual”, represented by software and formulas, where training or executing a NN is performed, for example, by a conventional computer or GPU (such as computing device 100 in FIG. 1).

Neural networks or connectionist systems are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers.

NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g. as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g. artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of compute power, on the order of 10s or even 100s of Teraflops, or a large set of cores. On modern GPUs this can be done using 4,000-5,000 cores.

According to some embodiments, the machine learning based predictive model may be a reinforcement learning based model. Reinforcement learning algorithms may be based on dynamic programming techniques, and may include using a Markov decision process (MDP) such as a discrete-time stochastic control process. Reinforcement learning models may be advantageous over supervised learning models because they do not require labelled input data, and may be used where constructing an exact mathematical model is infeasible.

According to some embodiments, the machine learning based predictive model may be trained to predict behavior trends of the usage of storage data by the application based on a training set of time periods and data usage metrics corresponding to the set of time periods.

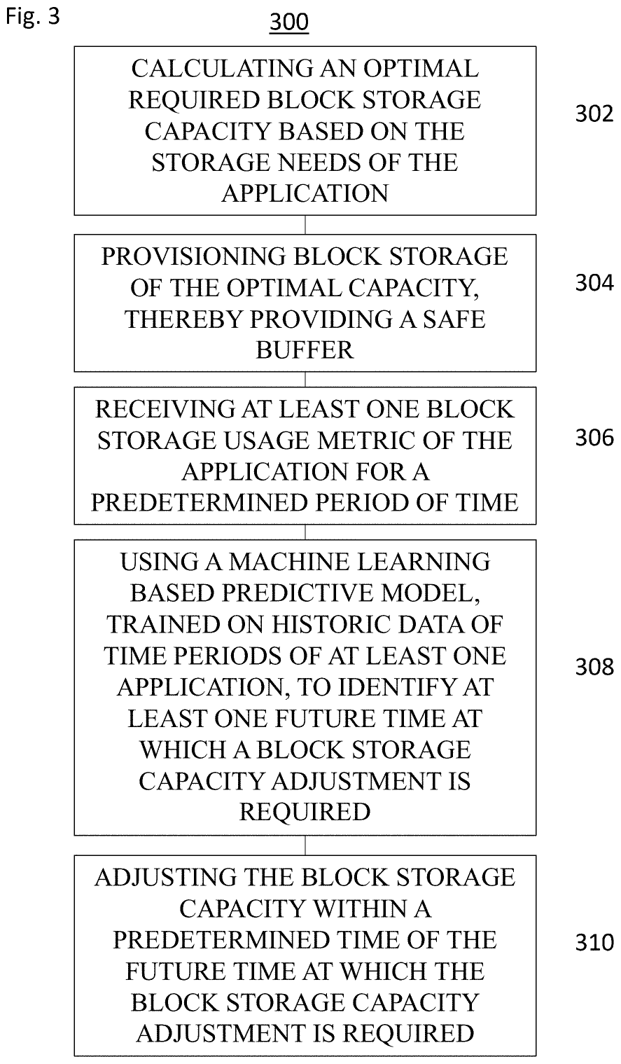

FIG. 3 shows a flowchart of a method 300 for managing block storage for an application according to some embodiments of the present invention. An application may be, for example, a piece of software executing on a computing device (e.g. computing device 100) and may also be referred to as an app. An app may generate data and may store this data on the cloud. A user of the app may have an agreement with a cloud storage provider (e.g. Amazon Web Services, the Microsoft Azure service) to provide a fixed amount of data storage. The agreement may work as a subscription model, for example with a monthly fee paid to keep the storage in use. Additional storage may be purchased, but this additional amount of storage may be far greater than required and money may be wasted on unused storage.

A method 300 according to embodiments of the invention may include calculating (302) an optimal required block storage capacity based on the storage needs of the application. Block storage may be, for example, a unit of data storage of a certain size, representing a capacity of data which can be stored in that block, e.g. in terms of megabytes (Mb), gigabytes (Gb), terabytes (Tb) etc. A plurality of block storage units may constitute a storage block, e.g. a storage block may include one or more units of block storage. Storage blocks, and thus block storage may be virtual volumes of storage associated with one or more virtual machines (VMs). A virtual machine is the virtualization or emulation of a computer system based on computer architectures. VMs may provide the functionality of a physical computer.

Calculating (302) an optimal required block storage capacity based on the storage needs of the application may involve, for example, determining the greatest lower bound of data storage required by the application. To give an analogy, a car with a top speed of 100 miles per hour may require one hundred miles of road for one hour of conventional (e.g. not off-road) travel. If the car travels at 30 mph, it will only require 30 miles of road. Accordingly, 100 miles of road is the greatest of the lower bounds. Storage needs of the application may be governed by the running processes (various applications, services, databases etc.) which use filesystems to create and delete files and/or folders according to their internal logic (a database could store each table as a separate file, for example). When a file is created, the filesystem is responsible for allocating the required amount/number of blocks on the block storage so that the file can be successfully written. The filesystem determines the size of a single block (typically, the default block size is 4 kb).

Method 300 may include provisioning (304) block storage of, equal to or defined by the optimal capacity, thereby providing a safe buffer. Provisioning may include obtaining storage from a third party storage provider, for example by reserving or assigning a portion of storage. Alternatively, provisioning may include creating the required storage. Provisioning an optimal capacity of blocks (e.g. the requested cloud volume capacity from a cloud vendor), may be determined by an amount of blocks already used (e.g. used by the filesystem to store the data) and a safe buffer. The used capacity is typically measured in kilobytes but is not limited to this alone. The capacity requested from the cloud vendor is typically measured in gigabytes, but is not limited to this alone. A safe buffer may mean the maximum write speed of a block storage device or plurality of block storage devices combined in stripe. A safe buffer may determine how many blocks can be written in a period of time (120 MB/sec, for example), to guarantee enough free blocks even in case the data will be written at the maximum possible speed. In other words, a safe buffer may refer to an amount of storage required to allow the app to run at full capacity if needed, as in the above car and road example: the app may not utilize all the provided storage at once, but there may be a sufficient amount provided to cover such a case if required.

Method 300 may include receiving (306) at least one block storage usage metric/measurement of the application, potentially for a predetermined period of time (e.g. receiving the number of write operations for the last 3 hours). A block storage metric may be an indicator of how the application is using the provided storage. Examples of block storage metrics may be: input/output operations per second (IOPS); read/write bandwidth e.g. in kb/s; read/write throughput e.g. in operations per second; average queue length e.g. in terms of number of operations; average read/write size e.g. in kb per operation; and average read/write latency e.g. in ms per operation. The predetermined period of time may be any time frame or period suitable to obtain a meaningful insight into how the application is using the provided storage, for example a sample of used capacity and free capacity metrics may be enough to determine if a safe buffer is maintained and there is no potential risk of running out of free space.

Method 300 may include using (308) a machine learning based (e.g. predictive) model, trained on, for example historic data of time periods of at least one application and/or storage usage, to identify at least one future time or period at which a block storage capacity adjustment/change is required. The machine learning based predictive model may be for example a reinforcement learning model and/or neural network. The historic data may represent past (e.g. immediate past) usage of storage by the application or of other applications. Historic data may also include used capacity, total capacity and free capacity measured, for example, in kilobytes. For example, applications in similar sectors (e.g. financial) may have similar storage usage trends quantified by one or more block storage usage metrics, and so previous data from one application may be useful in predicting storage usage behavior trends for other applications.

A future time or period at which block storage capacity adjustment or change is required may be a predicted upcoming time at which the application requires more or less storage than is currently provisioned. For example, the machine learning based predictive model may identify that on weekends less data is generated which needs to be stored. Accordingly, an upcoming weekend may be identified by embodiments of the invention as a future time at which less data storage is required. Storage may then be reduced automatically in response to the prediction, for example by removing a block storage unit, as described herein.

Method 300 may include adjusting (310) the block storage capacity within a predetermined time of the future time at which the block storage capacity adjustment is required. For example, if the machine learning based predictive model predicts that the application will require more storage at 14:00 (e.g. the future time), embodiments of the invention may make an adjustment at 13:30 (e.g. within a predetermined 30 minute timeframe of the future time of 14:00) in preparation for the time at which the change in storage requirements is predicted to happen, in this example 14:00.

A block storage capacity adjustment may include identifying, e.g. by the predictive model, at least one future time at which the application requires less block storage than is currently provisioned. A surplus capacity of block storage may then be removed within a predetermined time of the future time at which the surplus storage is not required. Removed surplus block storage for the application (e.g. first application) may be used as additional block storage for a second (e.g. different) application.

Alternatively, or complementarily, a block storage capacity adjustment may include identifying, e.g. by the predictive model, at least one future time at which the application requires more block storage than is currently provisioned, and embodiments of the invention may accordingly set to provisioning, e.g. from at least one block storage provider, a required additional capacity of block storage within a predetermined time of the future time at which the required storage is required. In some embodiments, storage is created independently, e.g. without engaging and purchasing storage from a third party cloud block storage provider.

Accordingly, embodiments of the present invention may dynamically adjust (e.g. increase and/or decrease) a storage capacity of an application in response to predicted future needs/requirements. Embodiments of the invention may add or remove storage in good time prior to the time at which such adjustment is required.

Embodiments of the present invention may include predicting, e.g. by the predictive model, a response time of at least one block storage provider to fulfil a request for block storage capacity adjustment. For example, data obtained from a block storage provider on the time taken to make storage available (e.g. publicly available in a Frequently Asked Questions “FAQ” or on request as part of a quote) may be used by the model (or computing device executing the model) to improve predictions by factoring this response time into the prediction. In this way, embodiments of the invention may ensure that any potential delays in adding or offloading storage are factored into the scheduling of adjusting the storage in sufficient time of the time at which the adjustment is required.

According to some embodiments, provisioning a required additional capacity of block storage may include comparing a block storage cost among more than one block storage provider and provisioning block storage from the block storage provider offering the lowest cost for the required block storage. In this way, embodiments of the invention may take into account a cost analysis from different providers in making the storage available, and thereby allow for the most economically viable option. In some embodiments there may a reimbursement/refund for unused/removed storage.

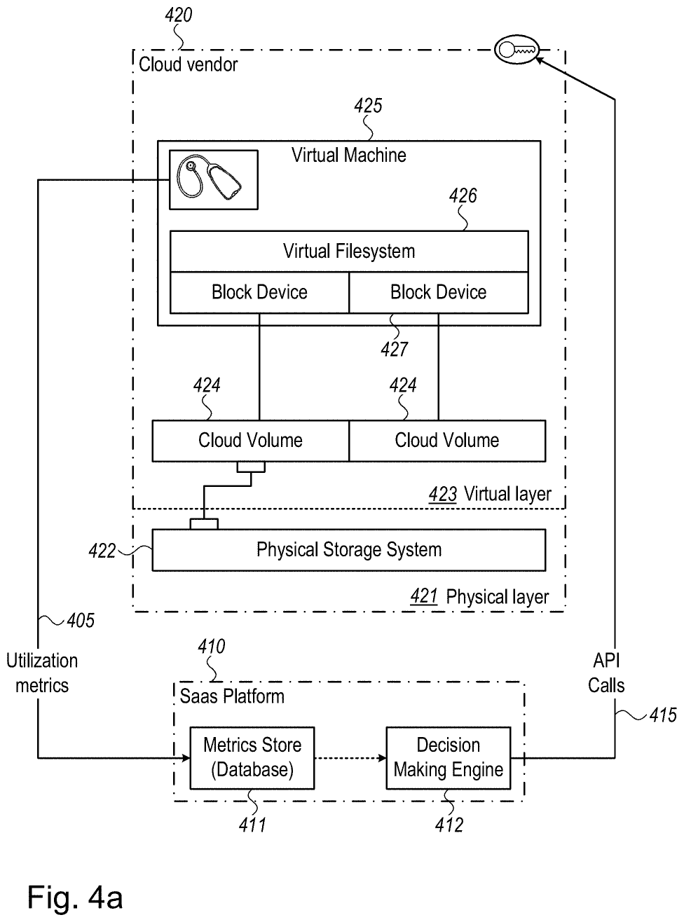

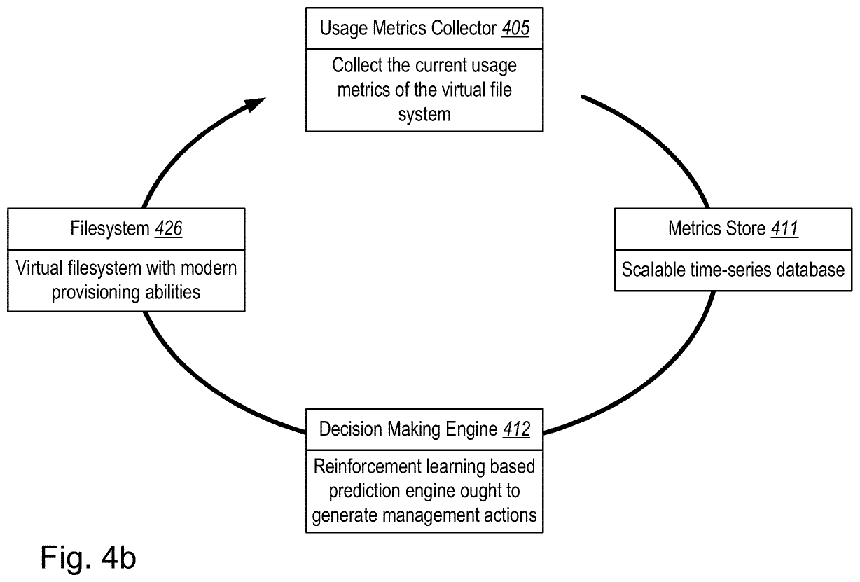

According to some embodiments, the block storage may include a plurality of storage blocks associated with at least one virtual block storage volume, wherein the plurality of storage blocks includes at least one storage block of a first capacity, and at least one storage block of a capacity different to the first capacity. For example, a first block of 1 Tb and another block of 50 Gb. The at least one virtual block storage volume may be distributed over one or more physical disks (e.g. included in the physical storage system 422 of FIG. 4A).

A block storage capacity adjustment may include, according to some embodiments, removing surplus block storage starting with the storage block containing the least amount of stored data based on a file system analysis of the application indicating which storage blocks contain data which is no longer required. For example, among blocks storing 1 Gb, 5 Gb and 10 Gb of data, the block storing 1 Gb of data contains the least amount of stored data, because 1<5<10. A file system analysis may be useful in identifying how data has been allocated within the storage blocks, and may prevent removal of a storage block which contains stored data. As is known in the art, the writing of data at the physical layer (e.g. on a physical disk) is random. Accordingly, virtual storage over a physical layer may also result in data being stored randomly to the available storage blocks. Storage blocks of differing sizes may therefore have a different distribution of stored data because, for example, a “larger” storage block has more “places” to store data and so it is more likely (e.g. higher probability) that data will be stored in at least one place in the “larger” storage block, as compared to a “smaller” storage block which has fewer places to store data.

FIG. 4A shows how embodiments of the invention, for example as a SAAS platform 410, may interact with a cloud vendor (e.g. a block storage provider) 420.

Cloud vendor 420 (which may operate as a server such as server 220, and/or may be a computing device such as is shown in FIG. 1) may provide cloud volume/block storage and may accommodate a physical layer 421. Physical layer 421 may include a physical storage system 422. A virtual layer 423 may exist over physical layer 421. Virtual layer 423 may include one or more cloud volumes 424 and one or more virtual machines 425. Virtual machine 425 may include a virtual filesystem 426, which may include one or more block devices 427. A cloud-based application requiring cloud-based storage as discussed herein, may be executed on virtual machine 425. Cloud vendor 420 may “house” the provisioned storage volumes discussed herein, for example by storing data on cloud volumes 424 of a virtual layer 423 supported by a physical storage system 422 of a physical layer 421. A safe buffer of data storage may be provided by providing/provisioning a plurality of cloud volumes 424, of a total storage size equal to or greater than an optimal capacity based on the storage needs of the application.

To achieve efficient application continuity and stability, filesystem awareness may be critical. A SAAS platform 410, according to embodiments of the invention, may analyze virtual filesystem 426 when making storage adjustment decisions based on predictions of upcoming storage usage, e.g. by receiving at least one block storage usage metric of the application.

SAAS platform 410 may execute on a computing device, such as computing device 100 of FIG. 1. SAAS platform 410 may include a metrics collector 405, for example executable code designed to collect block storage utilization metrics. Metrics collector 405 may be deployed on (e.g. interact with) virtual machine 425 to measure application specific disk usage and report these data to a centralized metrics store 411, such as a database. Utilization metrics may include data, for example block storage usage data, on how the app is using cloud storage.

SAAS platform 410 may also include a decision making engine/module 412. Decision making engine 412 may include a machine learning based predictive model. Metrics collected by metrics collector 405 and stored in metrics store 411 may be processed in real-time by decision making engine 412, for example, on the order of milliseconds or sometimes microseconds.

Decision making engine 412 may generate management actions (e.g. a block storage capacity adjustment) based on the received usage metrics and may evaluate them in light of the physical speed limitations of the cloud volume (e.g. write throughput and IOPS) dictated by the block storage type (e.g. Solid State Drive “SSD”) and cloud vendor's application programming interface (API) response times in a specific datacenter. This approach may fuse a set of execution plans with named actions to be taken. Actions may be API calls 415, for example:
Add disk—which translates to a cloud API call to create a new block storage volume, attach it to a virtual machine, such as virtual machine 425, and a filesystem call to extend the filesystem redundant array of independent disks (RAID) strip to make the newly added space available;
Remove disk—which translates to a filesystem call to distribute used data blocks between the other block device(s). Once all blocks are migrated, the disk may be detached from the virtual machine using a cloud API call;
Cancel disk removal—which translates into a filesystem call to abort running the disk removal process;
Expand disk—which translates into a cloud API (if available) and once the extension completes, a filesystem call to extend the filesystem triggered; and
Shrink—which translates into a filesystem call to initiate gradual filesystem reduction and block defragmentation process.

The following filesystem capabilities may be used with embodiments of the invention: Copy-on-write of data and metadata; built-in RAID-0 (disk striping) with the ability to attach and detach block devices online; and online resizing and defragmentation. Embodiments of the invention may make use of a b-tree file system (btrfs).

FIG. 4B shows an interdependence of elements of FIG. 4A. For example, a usage metrics collector, such as metrics collector 405 may collect the current usage metrics of the virtual file system (e.g. virtual file system 426). Metrics collected by metrics collector 405 may be stored in metrics store 411, which may be a scalable time-series database, e.g. a database containing time series data which can be added to/scaled up with further datapoints collected at future times. Decision making engine 412 may use the metrics store 411 to make decisions, such as management actions. Decision making engine 412 may be a reinforcement learning based prediction engine. Virtual filesystem 426 may be adjusted (e.g. by having its storage increased and/or decreased) by actions taken by decision making engine 412. Virtual filesystem 426 may be equipped with modern provisioning abilities such as copy-on-write of data and RAID-0 disk striping. Virtual filesystem 426, potentially adjusted as described herein, may be continuously monitored by metrics collector 411, and thus a feedback loop may be generated providing continual monitoring, analysis, decision and adjustment of storage use and provisioning.

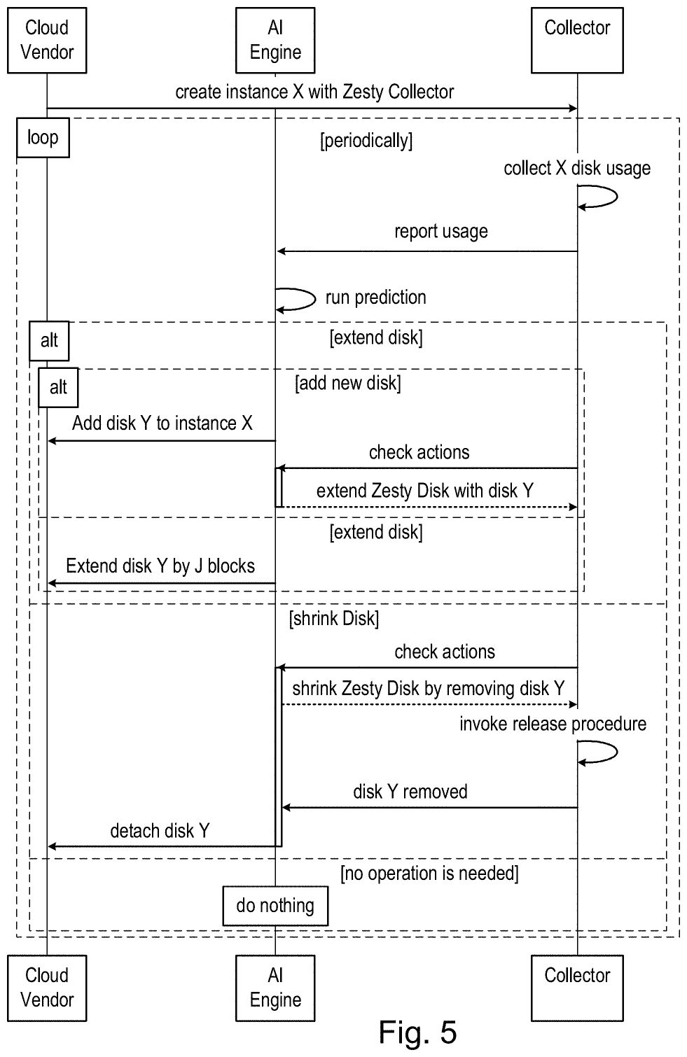

FIG. 5 shows a sequence diagram according to an embodiment of the invention. A sequence diagram such as that in FIG. 5 may show in schematic fashion a series of operations and calls (e.g. API calls) between different entities involved in the process, such as a cloud vendor, an AI engine (e.g. decision engine 412 and/or machine learning based predictive model) and a collector (e.g. metrics collector 411).

In an initial stage, the cloud vendor may create an instance (e.g. instance “X”) with a collector. For example, a metrics collector may be installed or otherwise created to monitor a virtual filesystem of an application running with the cloud vendor. The collector may be referred to under a trade name, for example a “Zesty collector” as may be provided by Zesty tech LTD.

The collector may periodically (e.g. every ten minutes), or alternatively continuously, collect disk usage metrics e.g. from disk X. The collector may report these usage data to the AI engine. The AI engine may run a prediction. On the basis of the prediction, the AI engine may make a decision.

For example, the AI engine may decide to extend the disk e.g. if the prediction estimates that more storage is required than is currently provisioned. The AI engine may instruct the cloud provider to extend a disk, such as a disk Y, by J blocks, for example by three blocks of 10 Gb.

The AI engine may decide to add a new disk on the basis of the prediction. For example, the AI engine may instruct the cloud provider to add a disk, such as a disk Y, to disk X. The collector may check the actions taken and may extend the analysis of the filesystem (which may be referred to as a “Zesty disk”) to include an analysis of disk Y.

Alternatively, the AI engine may decide to shrink disk space on the basis of the prediction. A disk, such as a disk Y, may be removed a release procedure may be invoked. The collector may thus stop monitoring disk Y. The cloud provider may detach disk Y.

In some situations, the AI engine may, on the basis of its prediction for upcoming storage needs, decide that no action/operation needs to be taken, and may correspondingly do nothing until receiving the next set of usage metrics.

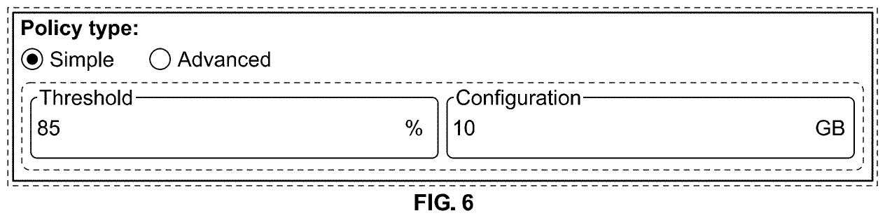

Some embodiments of the invention include managing computer block cloud volume storage for a computer application. FIG. 6 shows an example user interface, according to some embodiments of the invention. A user may be able to define a policy for storage adjustment, separate to adjustments made based on predictions by a machine learning model and/or AI engine.

The policy may be, for example, a so-called simple policy or a so-called advanced policy. A simple policy may include, for example, providing a threshold storage utilization value and a storage factor. The threshold storage utilization value and storage factor may be associated with a storage action, which may be, for example, a storage increase or a storage decrease.

As an example using the values in FIG. 6, if the storage action is a storage increase, then based on the simple policy shown in FIG. 6 an available size (e.g. an amount already provided or accessible to the application from a storage provider such as a data center in multiples of bytes such as megabytes “MB”, gigabytes “GB”, terabytes “TB” etc.) of computer block cloud volume storage may be increased by 10 GB when the utilization of the storage passes the threshold value of 85%. The available size of computer block cloud volume storage which is adjusted may be an amount of cloud storage provided to or accessible to an application in line with, for example, a service agreement or data storage plan that is in place (for example the application may have an initial 10 GB plan, a 100 GB plan, a 1 TB plan etc.). Embodiments of the invention may increase or decrease (e.g. adjust) data storage provided as part of such an initial plan in line with utilization of the storage available on the plan. For example, as shown in FIG. 6, if the available computer block cloud volume storage before the adjustment is 100 GB then once 85 GB has been used (85% of 100 GB is 85 GB) computer implemented methods and/or systems according to embodiments of the invention may increase (e.g. by providing additional virtual volumes over a physical disk, adding additional disks, or acquiring storage from a cloud block storage provider) the available storage by 10 GB, so that the total available storage increases to 110 GB and changing the utilization to approximately 77.3% (85 GB is −77.3% of 110 GB), bringing the utilization back below the defined threshold of 85%. The policy may be triggered again at future times when the storage utilization again passes the threshold storage utilization value (e.g. the policy will trigger for a second time in the above example when the storage utilization passes 93.5 GB since 85% of 110 GB is 93.5 GB), and the available size of computer block cloud volume storage may again be increased by an amount based on the storage factor.

The storage factor may be a percentage value of computer block cloud volume storage utilization, or an absolute value of computer block cloud volume storage (e.g. in multiples of bytes). For example, in FIG. 6 the storage factor is given as 10 GB, which is an absolute value of storage which may be added or removed based on the storage action (e.g. 10 GB added when the storage action corresponds to a storage increase, and 10 GB removed when the storage action corresponds to a storage decrease).

A percentage storage factor may be desirable when the policy (e.g. the storage action) relates to a storage decrease. For example, when the storage utilization passes below 85% utilization, embodiments of the invention may remove 10% of the available storage, which may be more efficient than removing a fixed amount (e.g. absolute value) of storage, especially for large initial values of available storage which is going unutilized.

The user defined input which may provide selection of the storage action, storage factor and/or threshold storage utilization value may be in the form of sliders, toggles, numeric entry, selection from one or more lists, or the like.

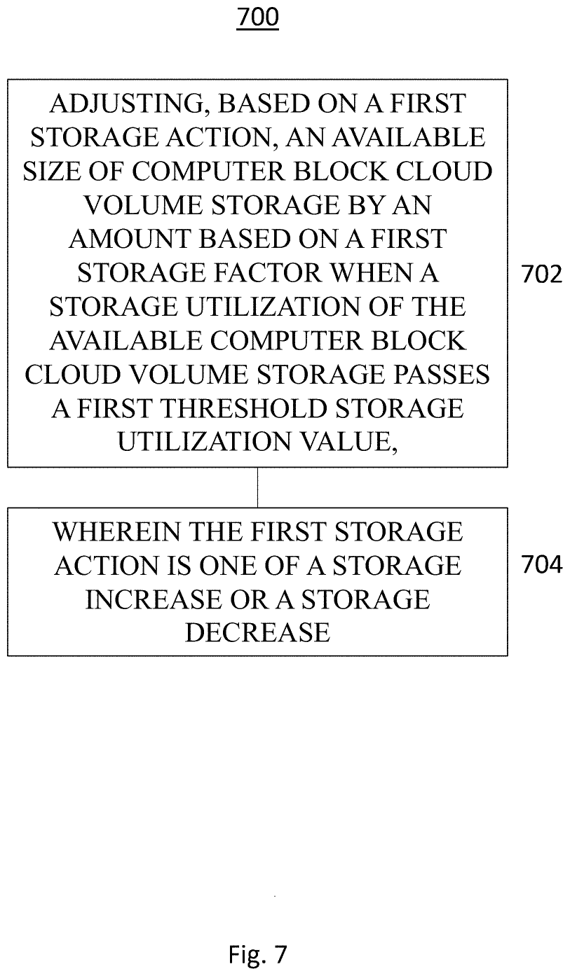

With reference now to FIG. 7, there is provided a method 700 for managing computer block cloud volume storage for a computer application.

Method 700 may include adjusting, based on a first storage action, an available size of computer block cloud volume storage by an amount based on a first storage factor when a storage utilization of the available computer block cloud volume storage passes, e.g. increases beyond or decreases below, a first threshold storage utilization value (702).

The first storage action may be one of a storage increase or a storage decrease (704). As discussed with reference to FIG. 6, the first storage action, the first storage factor, and the first threshold storage utilization value may be received as part of a user-defined input. In some embodiments, the first storage factor is a percentage value of computer block cloud volume storage utilization, or an absolute value of computer block cloud volume storage.

In some embodiments, method 700 may include adjusting, based on a second storage action, the available size of computer block cloud volume storage by an amount based on a second storage factor when a storage utilization of the available computer block cloud volume storage passes a second threshold storage utilization value. The first storage action may be a storage increase, and the second storage action may be a storage decrease. The second storage factor may be a percentage value of computer block cloud volume storage utilization, or an absolute value of computer block cloud volume storage, and may be received as part of a user defined input along with the second storage action and second threshold storage utilization value.

The first and second storage actions may be implemented by a single policy or two separate policies. For example, the first storage action may be a storage increase, and the second storage action may be a storage decrease, thereby defining a joint policy for storage increase and/or storage decrease depending on the utilization.

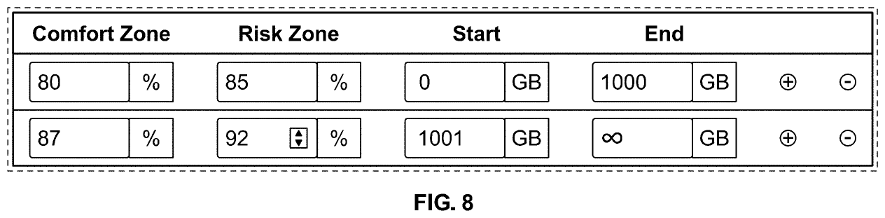

FIG. 8 shows an example user interface according to some embodiments of the invention. Where FIG. 6 shows a so-called simple policy, FIG. 8 shows a so-called advanced policy. An advanced policy may allow a user to define different thresholds depending on multiple filesystem size brackets. For example, the example policy shown in FIG. 8 has the following effects: when the size of the filesystem is between 0 GB to 1000 GB and the block storage capacity reaches 85% utilization, the policy will increase the block storage capacity to get back to 80% utilization. When the filesystem is between 1001 GB to infinity and the block storage capacity reaches 92% utilization, the policy will increase the block storage capacity to get back to 87% utilization.

Such an approach may allow greater storage management efficiency as growing by 10% is reasonable when the filesystem is relatively small, however, adding an extra 10% to a 5 TB filesystem may be wasteful (e.g. it may not be fully utilised for a long period) and may be costly.

As seen in FIG. 8, the terms comfort zone and risk zone may be used when describing a so-called advanced policy according to embodiments of the invention. A risk zone may correspond to the previously described threshold storage utilization value in that such value represents a risk (e.g. in the mind of the user defining the policy) of surpassing the available storage. A comfort zone may correspond to the previously described storage factor in that such value represents a percentage value utilization which leaves a sufficient value of surplus storage for future application needs.

A user may set a risk zone and comfort zone percentage utilization values based on knowledge they have of their computer application's storage needs. A user may supplement this knowledge with predictive insights into future storage utilization using machine learning models for example as described herein. A machine learning model may automatically provide values which a user may refine before defining a policy.

Returning to method 700, according to some embodiments, the first threshold storage utilization value represents a risk zone percentage value utilization, and the first storage factor represents a comfort zone percentage value utilization, wherein said adjustment is of a size which results in the storage utilization of the available computer block cloud volume storage changing from the risk zone percentage value utilization to the comfort zone percentage value utilization.

Using the example of FIG. 8 if the available storage is 1000 GB then a risk zone percentage utilization of 85% means that 850 GB has been used. The comfort zone percentage value utilization is defined as 80%, thus the policy must increase the available storage by an amount X GB such that the utilised 850 GB is 80% of the increased storage 1000 GB+X GB. Solving for X requires that in this example the policy should increase the available storage by 62.5 GB to a total of 1062.5 GB such that an 80% percentage value utilization of this total storage is 850 GB. Thus, an adjustment (in this example an increase) of 62.5 GB results in the storage utilization (850 GB) of the available computer block cloud volume storage changing from the risk zone percentage value utilization (85%) to the comfort zone percentage value utilization (80%).

The filesystem size brackets of FIG. 8 (e.g. start to end) may be used to further define activation/triggering of the user-defined policies. For example, if the available storage is 1001 GB, then the part of the policy of FIG. 8 for values between 0 GB and 1000 GB does not apply, and will not be implemented. Accordingly, method 700 may further include performing said adjustment only if the available computer block cloud volume is within a predefined size range.

Some embodiments of the invention include a system for managing computer block storage for a computer application. Such a system may implement methods described herein, such as method 700. The system may include at least one processor and a memory containing instructions which, when executed by the at least one processor, cause the at least one processor to carry out methods described herein. The system may be, or may be include, one or more computing devices such as shown in FIG. 1

The at least one processor may be configured to adjust, based on a first storage action, an available size of computer block cloud volume storage by an amount based on a first storage factor when a storage utilization of the available computer block cloud volume storage passes a first threshold storage utilization value. The first storage action may be one of a storage increase or a storage decrease, as described herein. The first storage factor may be a percentage value of computer block cloud volume storage utilization, or an absolute value of computer block cloud volume storage. The first storage action, the first storage factor, and the first threshold storage utilization value may be received as part of a user-defined input, such as by defining a policy such as shown in FIGS. 6 and 8.

In some embodiments, the first threshold storage utilization value represents a risk zone percentage value utilization, and the first storage factor represents a comfort zone percentage value utilization, wherein the adjustment by the processor is of a size which results in the storage utilization of the available computer block cloud volume storage changing from the risk zone percentage value utilization to the comfort zone percentage value utilization. An example policy which systems according to embodiments of the invention may implement is shown in FIG. 8 and described herein.

In some embodiments, the at least one processor is configured to perform the adjustment only if the available computer block cloud volume is within a predefined size range. For example, in one implementation an adjustment policy (e.g. storage increase and/or storage decrease) may only be implemented if the available storage is between 0 GB and 1000 GB, for example.

The at least one processor may be configured to adjust, based on a second storage action, the available size of computer block cloud volume storage by an amount based on a second storage factor when a storage utilization of the available computer block cloud volume storage passes a second threshold storage utilization value. For example, the first storage action may be a storage increase, and the second storage action may be a storage decrease, thereby defining a joint policy for storage increase and/or storage decrease depending on the utilization.

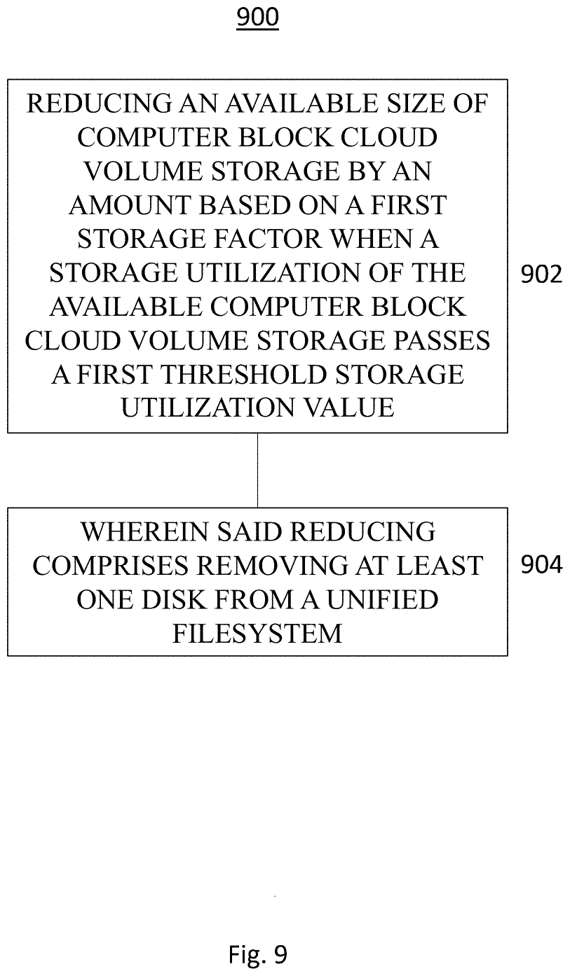

With reference to FIG. 9, some embodiments include method 900 for reducing computer block cloud volume storage for a computer application. Method 900 may include reducing an available size of computer block cloud volume storage by an amount based on a first storage factor when a storage utilization of the available computer block cloud volume storage passes a first threshold storage utilization value (902). As described herein, the first storage factor may be a percentage value of computer block cloud volume storage utilization, or an absolute value of computer block cloud volume storage. The first storage action, the first storage factor, and the first threshold storage utilization value may be received as part of a user-defined input.

As part of method 900, the reducing may include removing at least one disk from a unified filesystem.

Embodiments of the invention may improve storage technology, for example by allowing for rapid, near instantaneous removal of storage, in comparison to other storage providers. For example, most storage providers do not allow for removal of storage from a file system, and will require moving to a different sized storage plan with a different filesystem. This process may take up to 6 hours, for example, because data must be copied from one disk to another disk. Embodiments of the invention may significantly reduce this time due to removing at least one disk from a unified filesystem (e.g. a filesystem across a plurality of disks).

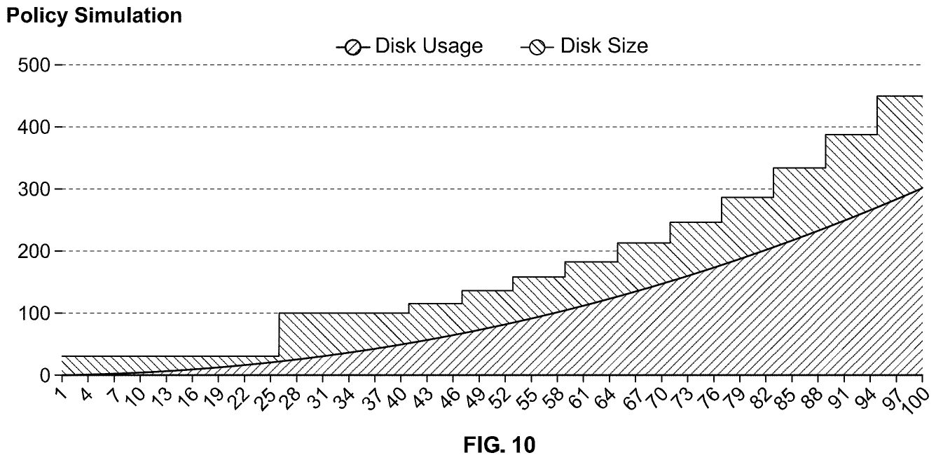

FIG. 10 is a graph of a simulation, according to some embodiments of the present invention. The Y-axis shows storage in tens of gigabytes, and the X-axis shows time (e.g. in days). As can be seen, as disk usage increases the disk size is increased in a step-wise manner. The graph visually demonstrates extension of storage at 80% utilization. It can be seen how the system keeps a safe buffer as the usage grows.

Embodiments of the present invention may be applicable to any cloud that supports the notion of attaching block storage volumes to a virtual machine, regardless of whether the cloud is a public cloud. In particular, embodiments of the present invention may be applied to private, government, and even on-premises clouds, and without limitation to other cloud types not discussed here.

Embodiments of the invention may have the advantage of eliminating the need for manual capacity planning by cross-referencing application storage usage pattern, cloud volume limitations dictated by the volume type (e.g. write throughput and IOPS), and the cloud provider's response times in order to make a prediction of the needed storage capacity. Embodiments may automatically provision or shrink that capacity while making sure to maintain a safe buffer, thereby guaranteeing application stability, availability, and performance whilst relieving engineers from manually managing storage volumes and reducing storage costs.

Embodiments of the invention may improve the technologies of computer automation, big data analysis, and computer use and automation analysis by using specific algorithms to analyze large pools of data, a task which is impossible, in a practical sense, for a person to carry out.

Embodiments of the invention may improve computer storage technology by allowing for rapid adjustment of storage size, of timescales shorter than those available commercially at present. Embodiments may also allow the reduction of storage, which is not typically provided commercially at present.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

The description also includes the subject matter of the following clauses:

Clause 1. A method for managing computer block storage for a computer application, the method comprising:
calculating an optimal required block storage capacity based on the storage needs of the application;
provisioning block storage of the optimal capacity;
receiving at least one block storage usage metric of the application;
using a machine learning based model, trained on historic data of at least one application, to identify at least one future time at which a block storage capacity adjustment is required; and
adjusting the block storage capacity within a time of the future time at which the block storage capacity adjustment is required.

Clause 2. The method of clause 1, wherein the block storage capacity adjustment comprises:
identifying, by the model, at least one future time at which the application requires less block storage than is currently provisioned; and
removing a surplus capacity of block storage within a time of the future time at which the surplus storage is not required.

Clause 3. The method of clause 1, wherein removed surplus block storage for the application is used as additional block storage for a second application.

Clause 4. The method of clause 1, wherein the block storage capacity adjustment comprises:
identifying, by the model, at least one future time at which the application requires more block storage than is currently provisioned; and
provisioning, from at least one block storage provider, a required additional capacity of block storage within a time of the future time at which the required storage is required.

Clause 5. The method of clause 4, wherein the step of provisioning the required additional capacity of block storage comprises:
comparing a block storage cost among more than one block storage provider; and
provisioning block storage from the block storage provider offering the lowest cost for the required block storage.

Clause 6. The method of clause 1, wherein the block storage is cloud block storage.

Clause 7. The method of clause 1, further comprising predicting, by the predictive model, a response time of at least one block storage provider to fulfil a request for block storage capacity adjustment.

Clause 8. The method of clause 1, wherein block storage comprises a plurality of storage blocks associated with at least one virtual block storage volume,
wherein the plurality of storage blocks comprises at least one storage block of a first capacity, and at least one storage block of a capacity different to the first capacity, and
wherein the at least one virtual block storage volume is distributed over one or more physical disks.

Clause 9. The method of clause 8, wherein a block storage capacity adjustment comprises removing surplus block storage starting with the storage block containing the least stored data based on a file system analysis of the application indicating which storage blocks contain data which is no longer required.

Clause 10. The method of clause 1, wherein the machine learning based predictive model is one of: a neural network, and a reinforcement learning model.

Clause 11. The method of clause 1, wherein the machine learning based predictive model is trained to predict behavior trends of the usage of storage data by the application based on a training set of time periods and data usage metrics corresponding to the set of time periods.

Clause 12. A method for managing block storage for an application, the method comprising:
receiving at least one block storage usage measurement of the application;
using a machine learning model, trained on storage usage for at least one other application, to identify a period for storage change; and
adjusting block storage at or before the period.

Clause 13. The method of clause 11, wherein an initial minimum block storage size is provided based on the minimum block storage needs of the application.

Clause 14. The method of clause 11, wherein the block storage adjustment comprises:
identifying, by the predictive model, at least one period at which the application requires less block storage than is currently provisioned; and
removing an excess amount of block storage at or before the period at which the excess storage is not required.

Clause 15. The method of clause 11, wherein the block storage adjustment comprises:
identifying, by the predictive model, at least one future time at which the application requires more block storage than is currently provisioned; and
creating a required additional size of block storage within a predetermined time of the future time at which the required storage is required.

Clause 16. A system for managing computer block storage for a computer application, the system comprising:
a memory; and
a processor,
wherein the processor is configured to:
calculate an optimal required block storage capacity based on the storage needs of the application;
provision block storage of the optimal capacity;
receive at least one block storage usage metric of the application;
apply a machine learning based model, trained on historic data of at least one application, to identify at least one future time at which a block storage capacity adjustment is required; and
adjust the block storage capacity within a time of the future time at which the block storage capacity adjustment is required.

Clause 17. The system of clause 16, wherein the processor is configured to:
identify at least one future time at which the application requires less block storage than is currently provisioned; and
remove a surplus capacity of block storage within a time of the future time at which the surplus storage is not required.

Clause 18. The system of clause 16, wherein the processor is configured to:
identify at least one future time at which the application requires more block storage than is currently provisioned; and
provide a required additional capacity of block storage within a time of the future time at which the required storage is required.

Clause 19. The system of clause 16, wherein the machine learning based predictive model is trained on historic data of time periods for at least one other application.

Clause 20. The system of clause 16, wherein the processor is configured to perform at least one of: copy-on-write of data, and RAID-0 disk striping.

What is claimed is:

1. A method for managing computer block cloud volume storage for a computer application, the method comprising:
adjusting, based on a first storage action, an available size of computer block cloud volume storage by an amount based on a first storage factor when a storage utilization of the available computer block cloud volume storage passes a first threshold storage utilization value,
wherein the first storage action is one of a storage increase or a storage decrease.

2. The method of claim 1, wherein the first storage factor is a percentage value of computer block cloud volume storage utilization, or an absolute value of computer block cloud volume storage.

3. The method of claim 1, wherein the first storage action, the first storage factor, and the first threshold storage utilization value are received as part of a user-defined input.

4. The method of claim 1, wherein the first threshold storage utilization value represents a risk zone percentage value utilization, and wherein the first storage factor represents a comfort zone percentage value utilization,
wherein said adjustment is of a size which results in the storage utilization of the available computer block cloud volume storage changing from the risk zone percentage value utilization to the comfort zone percentage value utilization.

5. The method of claim 4, further comprising performing said adjustment only if the available computer block cloud volume is within a predefined size range.

6. The method of claim 1, comprising adjusting, based on a second storage action, the available size of computer block cloud volume storage by an amount based on a second storage factor when a storage utilization of the available computer block cloud volume storage passes a second threshold storage utilization value,
wherein the first storage action is a storage increase, and the second storage action is a storage decrease.

7. A system for managing computer block storage for a computer application, the system comprising:
at least one processor; and
a memory containing instructions which, when executed by the at least one processor, cause the at least one processor to:
adjust, based on a first storage action, an available size of computer block cloud volume storage by an amount based on a first storage factor when a storage utilization of the available computer block cloud volume storage passes a first threshold storage utilization value,
wherein the first storage action is one of a storage increase or a storage decrease.

8. The system of claim 7, wherein the first storage factor is a percentage value of computer block cloud volume storage utilization, or an absolute value of computer block cloud volume storage.

9. The system of claim 7, wherein the first storage action, the first storage factor, and the first threshold storage utilization value are received as part of a user-defined input.

10. The system of claim 7, wherein the first threshold storage utilization value represents a risk zone percentage value utilization, and wherein the first storage factor represents a comfort zone percentage value utilization,
wherein said adjustment is of a size which results in the storage utilization of the available computer block cloud volume storage changing from the risk zone percentage value utilization to the comfort zone percentage value utilization.

11. The system of claim 10, wherein said at least one processor is configured to perform said adjustment only if the available computer block cloud volume is within a predefined size range.

12. The system of claim 7, wherein said at least one processor is configured to adjust, based on a second storage action, the available size of computer block cloud volume storage by an amount based on a second storage factor when a storage utilization of the available computer block cloud volume storage passes a second threshold storage utilization value,
wherein the first storage action is a storage increase, and the second storage action is a storage decrease.

13. A method for reducing computer block cloud volume storage for a computer application, the method comprising:
reducing an available size of computer block cloud volume storage by an amount based on a first storage factor when a storage utilization of the available computer block cloud volume storage passes a first threshold storage utilization value,
wherein said reducing comprises removing at least one disk from a unified filesystem.
